(19) United States
(12) Patent Application Publication
(10) Pub. No.: US 2008/0155435 A1
(43) Pub. Date: Jun. 26, 2008

(54) SPATIALLY-DEFINED BOUNDARY AND PREDICATE TO PROVIDE INFORMATION

(75) Inventor: Todd C. Homa, Melrose Park, PA (US)

Correspondence Address: PETER M. ULLMAN LLC, PO BOX 6764, LAWRENCEVILLE, NJ, 08648-0764, US

(73) Assignee: Gestalt LLC, King of Prussia, PA (US)

(21) Appl. No.: 11/615,068

(22) Filed: Dec. 22, 2006

(51) Int. Cl. G06F 3/048

(52) U.S. Cl. 715/764

(57) ABSTRACT

An information seeker can graphically define a spatial sub-region of a geographic area and a predicate to be applied to objects and/or events in that sub-region. A system can then provide and/or evaluate information about entities that fall within the sub-region and that satisfy the predicate. The boundary of the sub-region may be defined as an arbitrary polygon. The information to be provided can be raw information about the entities, or information that is derived from analysis of those entities that satisfy the spatial predicate. The display of information about object and/or events that fall within a sub-region can be displayed on what may be referred to as a spatial dashboard.

### BACKGROUND

A dashboard can refer to the display of a set of metrics that provide key information about a project, process, or other concern. For example, a computer program may provide a dashboard for a sales manager that shows figures such as total sales, average sales per sale representative, average number of sales per day, etc. The actual metrics and information to be provided depend on the type of project, process or concern that is being analyzed.

Typical dashboards provide information about some fixed set of data, or over a pre-defined area. For example, it may be possible to compute metrics for all sales representatives in a company, all sales representatives in the United States, all sales representatives in the northeastern United States (where “northeastern United States” would refer to some pre-defined collection of states). However, the dashboard typically does not compute and show metrics over an arbitrarily defined area that has not been pre-defined—e.g., dashboards typically do not compute metrics over an arbitrary region defined by a user-specified polygon or other shape.

### SUMMARY

The subject matter described herein provides for a predicate to be applied to an arbitrarily-defined sub-region of a geographic region. A user specifies a sub-region of a geographic region (e.g., a polygon drawn around some arbitrary region in central Pennsylvania), and a predicate can be applied to the sub-region to compute a metric over the sub-region. The metric can be Boolean—e.g., the metric can determine whether some arbitrary set of criteria is, or is not met, by the objects and/or events within the sub-region. Or, the metric can be computational—e.g., the metric can compute some figures or other data, such as total sales within the defined sub-region. Information that comprises, or is based on, the results of applying the predicate to the sub-region is provided to a person, thereby allowing the person to receive the information requested about the sub-region that the person is interested in.

In one example, the subject matter described herein provides a system comprising: a display that shows a representation of a geographic region; an input device that receives a first specification of an arbitrary, non-predefined sub-region of said geographic region; one or more data remembrance devices; one or more processors; a communicative connection among said one or more data remembrance devices and said one or more processors; data pertaining to one or more objects or events, said data comprising: first data descriptive of locations, within said geographic region, of said one or more objects or events; and second data that pertains to one or more aspects of said one or more objects or events, said one or more aspects being other than the locations of said one or more objects or events; and a module that is stored in at least one of said one or more data remembrance devices, that is executable on at least one of said one or more processors, and that provides information, to a person, about those one or more objects or events that, according to said first data, stand, within a level of certainty, in a definable relationship to said sub-region.

In another example, the subject matter described herein provides one or more computer-readable storage media encoded with computer-executable instructions to perform a method, the method comprising: receiving a first specification describing an arbitrary, non-predefined sub-region of a geographic region; receiving data about one or more objects or events, said data comprising: first data descriptive of locations, within said geographic region, of said one or more objects or events; and second data that pertains to one or more aspects of said one or more objects or events, said one or more aspects being other than the locations of said one or more objects or events; and providing, to a person, information about those one or more objects or events that, according to said first data, stand, within a level of certainty, in a defined relationship to said sub-region.

In another examples, the subject matter described herein provides a method comprising: receiving a first specification describing an arbitrary, non-predefined sub-region of a geographic region; receiving a second specification of a predicate; receiving data about one or more objects or events, said data comprising: first data descriptive of locations, within said geographic region, of said one or more objects or events; and second data that pertains to one or more aspects of said one or more objects or events, said one or more aspects being other than the locations of said one or more objects or events; and displaying, on a screen, information comprising: a representation of said geographic region; an indication of said sub-region; and visual information indicative of whether those ones of said one or more objects or events that lie within said sub-region collectively satisfy said predicate.

Other features are described below.

### BRIEF DESCRIPTION OF THE DRAWINGS

FIG. 1 is a block diagram of a display that shows a geographic region and sub-region and accompanying information.

FIG. 2 is a block diagram of an interaction between a person and a system.

FIG. 3 is a block diagram of a system in which aspects of the subject matter described herein may be implemented.

FIG. 4 is a block diagram of data about objects and events that shows both location information and other information.

FIG. 5 is a block diagram of example predicates.

FIG. 6 is a flow diagram of an example process in accordance with the subject matter described herein.

### DETAILED DESCRIPTION

It is desirable to provide information about objects or events that fall within a spatially-defined area. For example, one may look a map of a geographic area (e.g., a map of Pennsylvania), and may wish to focus on objects or events that fall within some smaller sub-region of the geographic area (e.g., to focus all sales people located in a arbitrarily defined polygon in central Pennsylvania). It is desirable to be able to define, arbitrarily, the sub-region to be focused on, and then to evaluate a predicate over that sub-region.

For example, if one is the regional sales manager for Pennsylvania and wants to know what the total sales are in central Pennsylvania, one could open a map of Pennsylvania on a computer screen and then draw a rectangle (or polygon, or other shape) around a region in central Pennsylvania, and request that the total sales for that region over some period of time be calculated. As another example, one could define some sales goal (e.g., monthly sales exceeding $1 million per sales representative), and determine whether the representative within the defined sub-region are, on average, meeting or exceeding that goal. As a further example, one could ask to identify all sales representatives in a sub-region who have missed more than five days of work in the last month. These examples of requests for certain types of information are examples of predicates that can be applied to objects or events in a sub-region. (Objects includes both people and inanimate objects (e.g., sales representatives, cars, etc.); events includes things that can happen (e.g., car accidents, storms, etc.).)

A dashboard often refers to the display of a set of metrics that provide key information about a project, process, or other concern. It may be useful to introduce a spatial component to a dashboard—e.g., by being able to define an area over which the set of metrics is to be computed.

With reference to the drawings, example embodiments are now described.

FIG. 1 shows a display 102, which may, for example, take the form of a computer monitor. Graphics and text are displayed on display 102. Display 102 shows a geographic region 104 (which, in this example, is Pennsylvania), and a sub-region 106 of geographic region 104. Sub-region 106 may be defined by a polygonal boundary within geographic region 104, although a sub-region can also be defined by another type of boundary, such as a circle or other curve. Display 102 also shows information 108, which may comprise several lines of text 110. Information 108 may, for example, relate to geographic region 104 or sub-region 106. As further discussed below, information 108 may comprise information that a person has requested concerning object or events within sub-region 106.

In some contexts, the material shown on display 102 constitutes a “dashboard,” which sometimes refers to the display of a set of metrics that provide key information about a project, process, or other concern. As discussed below, a spatial definition of sub-region 106 can be used to specify what information a person would like to receive on a dashboard.

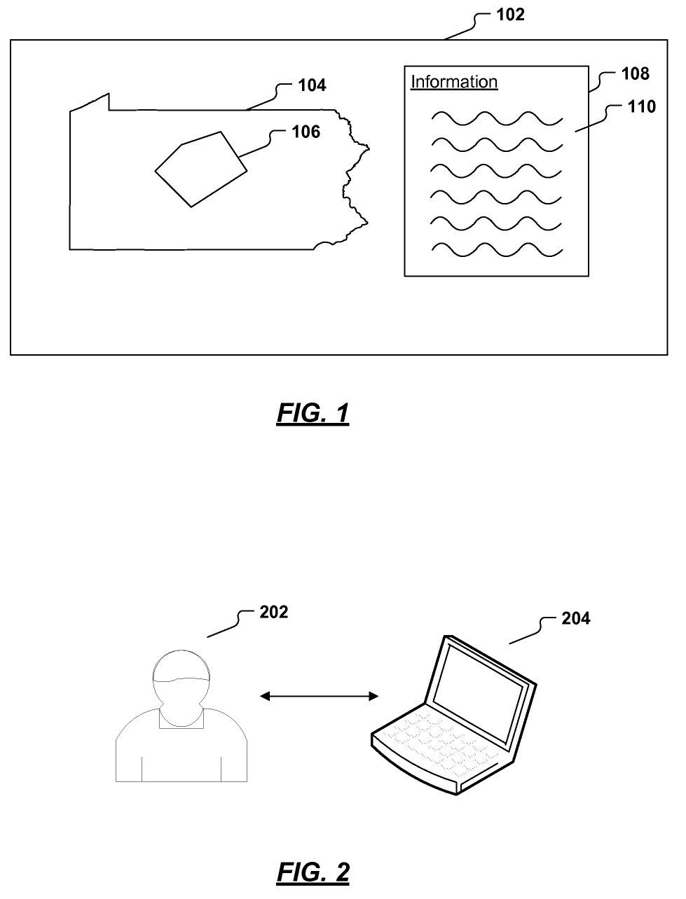

FIG. 2 shows an interaction between a person and a system. In particular, person 202 interacts with computer 204, by providing information to computer 204, and by receiving information from computer 204. Computer 204 may, for example, include or use a display, and the material shown on display 102, as shown in FIG. 1, may appear on the display of computer 204. When such material appears on display 204, the material is being provided to person 202. Moreover, computer 204 may have input devices, such as a keyboard or pointing device, that person 204 uses to provide information to computer 204. In one example, computer 204 has a tactilely-sensitive screen, or “touch screen,” which can receive input through touch by a finger or stylus. When computer 204 displays a geographic region 104 (shown in FIG. 1) on such a tactilely-sensitive screen, it may be advantageous for person 202 to define sub-region 106 (shown in FIG. 1) by drawing the boundary of sub-region 106 in the appropriate place such tactilely-sensitive screen.

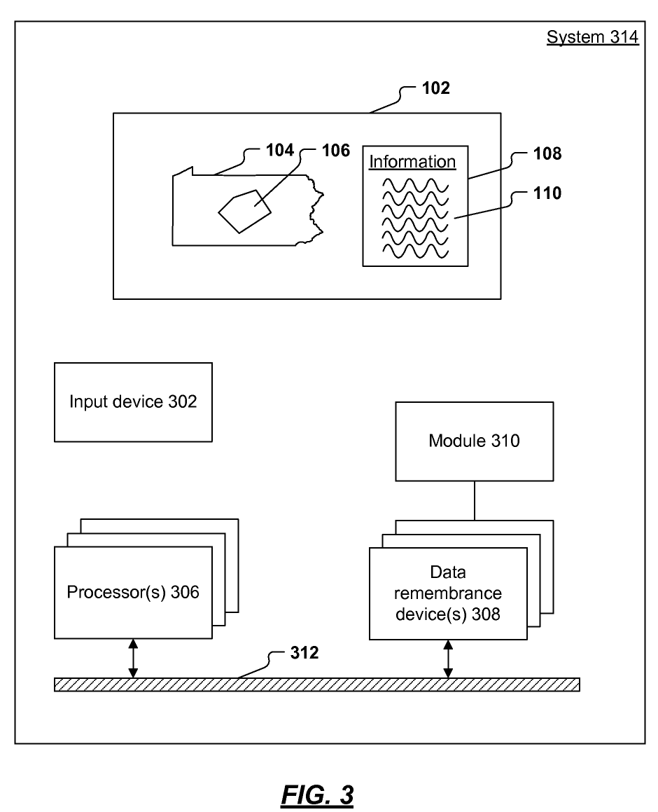

FIG. 3 shows a system 314 in which aspects of the subject matter described herein may be deployed. System 314 comprises display 102 (which, in this example, shows the same elements as appeared in FIG. 1—namely geographic region 104, sub-region 106, information 108, and text 110). System 314 comprises: an input device 302; one or more processors 306; one or more data remembrance devices 308; and a communicative connection 312, which enables communication among and between processors 306 and data remembrance devices 308. Module 310 comprises computer-executable instructions that are stored in one or more of data remembrance devices 308 and that are executable on one or more of processors 306.

Input device 302 is a device that a person (such as person 202, shown in FIG. 2) may use to provide data to system 314. A keyboard, a pointing device, and a tactilely-sensitive screen are all examples of input devices, and this list of examples is non-exhaustive. In an example where input device 302 is a tactilely-sensitive screen, display 102 and input device 302 may be the same device—that is, the same screen that is used to show items 104, 106, 108, and 110 to person 202 may also be used to receive input from person 202.

Processor(s) 306 may be any type of processors (such as the microprocessors commonly used in desktop computers), and need not all be the same type of processor.

Data remembrance device(s) 308 may be any type of device that is able to store and/or retain data, whether for short-term or long-term storage, and whether the device is volatile or non-volatile. Data remembrance devices 308 are not limited to any particular device or machine, and are not limited to any particular context in which data is retained. Volatile random access memory, read-only memory, flash memory, hard disk, floppy disk, optical disk, and magnetic tape, are all examples of data remembrance devices, and this list of examples is not exhaustive.

Module 310, as noted above, comprises computer-executable instructions that are stored in one or more of data remembrance devices 308 and that are executable on one or more of processors 306. For example, module 310 may comprise a computer program, or a part of a computer program, that performs some of the functions and actions of the subject matter described herein. For example, module 310 may interpret a specification of the boundary of sub-region 106, determine which objects and/or events are located within boundary 106, and apply some predicate (see below) to the objects and/or events within boundary 106.

Communicative connection 312 enables communication between and among processor(s) 306 and data remembrance device(s) 308. Thus, communicative connection 312 allows processors 306 to communicate with each other, or allows data remembrance devices 308 to communicate with each other, or allows a processor 306 to communicate with a data remembrance device 308. In one example, communicative connection 312 includes a system bus.

Data remembrance device(s) 308, in addition to storing module 310, may also store data 402, as shown in FIG. 4. Data 402, in this example, comprises two types of data: data 404 regarding locations of objects and/or events, and data 406 that pertain to objects and/or events in some way other than by describing the locations of the objects and/or events.

For example, data 404 may state that one event occurred at 39°N 75°W, another event occurred at 40°N 80°W, and an object is located at 41°N 77°W. The description of location in latitude and longitude is merely an example, and any other technique for describing location may be used.

Data 406 may describe information about objects and/or events other than their position. For example, data 406 may state that one object has not reported to work for five days, and that an event had an intensity of 500 kilojoules.

It should be noted at this point that an “object” can include anything that exists, and an “event” includes anything that can happen. Thus, an employee (e.g., one who has not reported to work for five days) is an example of an “object,” although object is not limited to employees or people. Similarly, and “event” could include a sudden discharge of energy that can be measured in kilojoules (as shown in FIG. 4), although it will be understood discharge of energy is merely one example of an event, and that “event” is not limited to such occurrences. The objects and events described in FIG. 4 are merely examples.

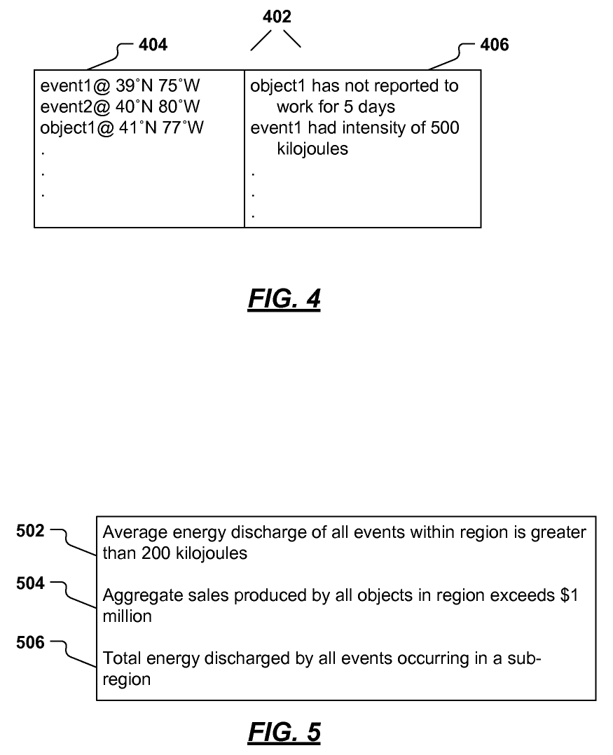

FIG. 5 shows examples of predicates that can be applied to events and/or objects within a sub-region. For example, predicate 502 is a Boolean predicate that is either true or false depending on whether the average energy discharge among all events in a sub-region is greater than 200 kilojoules. Predicate 504 is another Boolean predicate, which is either true or false depending on whether the aggregate sales produced by all objects in a sub-region exceed $1 million. Predicate 506 is a computational metric—i.e., it computes the total energy discharged by all events occurring in a sub-region. These are merely examples of predicates that can be defined.

Typically, these predicates can be applied by module 310 (shown in FIG. 3). In general, module 310 applies the predicate to object and/or events within a defined sub-region, and provides some results from the application of that predicate. The information that is provided to a person (e.g., to person 202, shown in FIG. 2) could either comprise the results themselves, or could be based on the results. The information can be provided in any form—e.g., as part of the information shown in FIG. 1, as part of an Online Analytical Processing (OLAP) crosstab sheet, etc. As another example, the predicate can be evaluated recurrently, and an trigger can be defined that creates an alert for the sub-region depending on the results of the predicate—e.g., if some metric defined in the predicate crosses a defined threshold. The alert could take the form, for example, of an on-screen text message, the highlighting of the sub-region on the display, a page to a telecommunications device, an e-mail to a specified address, etc.

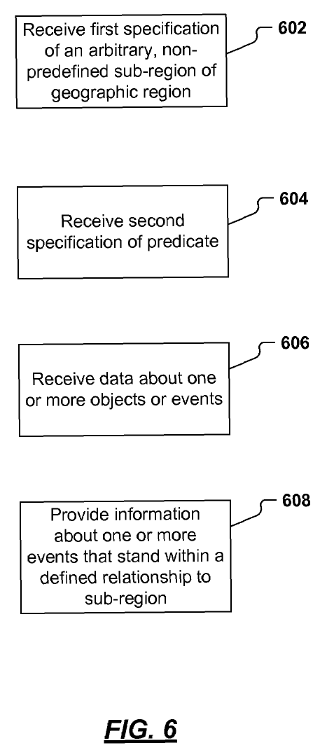

FIG. 6 is a flow diagram showing example actions that may be performed as part of a process. At block 602, a system receives a first specification of an arbitrary, non-predefined sub-region of a geographic region. (The notion of an arbitrary, non-predefined sub-region is further explained below.)

At block 604, the system receives a second specification, which specifies a predicate (such as one or more of the predicates discussed above in connection with FIG. 5).

At block 606, the system receives data about one or more objects or events. Data 402 (shown in FIG. 4) is an example of the kind of data that may be received at block 606.

At block 608, the system provides information about one or more events that stand within a defined relationship to a sub-region. (The notion of standing within a defined relationship to a sub-region is further described below.)

The following is an explanation of certain concepts relating to the subject matter described herein.

It may be said that a display (e.g., display 102, shown in FIG. 1) shows a representation of a geographic region. A map of a region (e.g., the map of Pennsylvania in FIG. 1) is an example of a representation of a geographic region. The geographic region itself is the land on which Pennsylvania is located; a map showing the boundaries that define Pennsylvania is a representation of that geographic region.

A specification of a sub-region includes input that allows the boundaries of a sub-region to be discerned. For example, if a tactilely-sensitive display shows a geographic region, and a person uses a stylus to draw a polygonal sub-region of the geographic region, then the drawing of the boundaries of the polygonal sub-region on the tactilely-sensitive screen is an example of a specification of a sub-region.

It may be said that an object or event stands in a definable relationship to a sub-region. In the preceding examples, a predicate is applied to object or events that lie within a sub-region, although it should be understood that “within” is merely an example of a definable relationship in which an object or event can stand to a sub-region. Other examples of such definable relationships are: the object or event touches a boundary of the sub-region; the object or event define an area that intersects with the sub-region (e.g., the object or events may be non-point events that have an area; it can be determined whether this area intersects the sub-region); the objects or events are outside of the sub-region.

It may further be said that an object or event stands in a definable relationship to a sub-region within a level of certainty. It will be understood that the position of an object or event may not be knowable to absolute certainty. For example, if a person is listed in data 402 (shown in FIG. 4) as being at a certain location but the data is thirty minutes old, it is possible that the person has moved from that location since the data is collected. It is still possible to say that the person may be within the sub-region, even if such cannot be said with 100% certainty. For example, it may be known to absolute or near-absolute certainty that an object or event is within a sub-region, or it may be a mere possibility that the object or event is within the sub-region. Both of these are examples of levels of certainty. Thus, it may be possible to say that a predicate is being applied to the objects and/or events that are within a sub-region, even if it is not known with absolute certainty that the objects and/or events are inside the sub-region.

A sub-region can be described as being arbitrary and non-predefined. Some systems could conceivably employ pre-defined regions, and allow objects and/or events to be analyzed over these regions. For example, a system that divided Pennsylvania into quadrants and allowed a user to evaluate objects or events within one of the quadrants (but that does not allow a user to define sub-regions other than those quadrants) would employ pre-defined sub-regions. By contrast, another system could allow a user to define sub-regions instead of limiting the user to pre-defined sub-regions. For example, a system that allows a person to define a sub-region as any arbitrary polygon would allow arbitrary, non-predefined sub-regions. A system that allows a person to define a sub-region as any arbitrary shape is also an example of a system that uses arbitrary, non-predefined sub-regions.

Some predicates, as noted above, are Boolean. Thus, the predicate is either satisfied by the sub-region or not. To say that the sub-region satisfies a predicate indicates that the objects and/or events within the sub-region (or, more generally, that stand within some definable relationship to the sub-region) meet the criteria specified in the predicate. For example, if the predicate is predicate 502, shown in FIG. 5 (i.e., that the average energy discharge of all events in a sub-region is greater than 200 kilojoules), then the predicate is evaluated (e.g., by module 310, shown in FIG. 3) by adding up the energy discharge of all events within a sub-region, dividing by the number of events, and determining whether the resulting quotient is greater than 200 kilojoules. If that number is greater than 200 kilojoules, then it can be said that the sub-region satisfies the predicate. It may be desirable to indicate on a display (e.g., display 102, shown in FIG. 1) whether the predicate has been satisfied. For example, the sub-region can be shaded in different colors depending on whether the predicate is satisfied or not (e.g., green for satisfied, red for not satisfied). A variation on this scheme is that sub-regions that are very close to the dividing line between satisfied and not satisfied can be shaded in a still different color. (E.g., if the average energy discharge is 199 kilojoules, the region could be shaded in yellow to indicate intensity, or to indicate that the amount of energy discharged is close to the defined threshold.)

Some predicates, instead of defining Boolean values, can define computational metrics. For example, predicate 506 (shown in FIG. 5) calls for computing a total amount of energy discharged, rather than computing a true-false value. In such a case, information 108 (shown in FIG. 1) could display a continually-updated value showing the total energy discharged.

It will be understood that the ability to provide information to a person about objects or events that fall within a spatially-defined area is advantageous and useful. It will further be understood that it is advantageous and useful to provide to a person information about whether the object or events in a spatially-defined area satisfy a predicate. It will further be understood that it is advantageous and useful to compute information about the objects or events in a spatially-defined area, and to provide that computed information to a person. It will further be understood that it is advantageous and useful to allow the above processes to be performed over a spatially-defined area that is not-predefined and that is specified as an arbitrary polygon or other shape.

### Example Implementations

The subject matter described herein can be deployed in the form of program code that executes on a computer or other type of computing device. The subject matter can be deployed using existing components, such as display monitors and computers that have processors and data remembrance devices, and the way in which such deployment of the novel subject matter can be performed will be apparent to those of ordinary skill in the relevant area. Additionally, existing shape-definition software can be used—e.g., existing software can be used to define a sub-region (e.g., by receiving the boundary of an arbitrary polygon to determine what points in a geographic region fall within that polygon), and the concepts described herein can be used to collect information about what objects and events stand in a particular relationship to that polygon, and further to apply a predicate to those objects or events.

Program code to implement the functionality described herein can be stored on one or more computer-readable media (e.g., optical or magnetic disk, tape, semi-conductor memory, etc.), and then loaded into the computing device that performs such functionality. The use of such media to store and load such program code is generally known in the relevant field.

Aspects of the subject matter described herein may be deployed in an apparatus that comprises one or more processors (e.g., one or more central processing units), and/or one or more data-remembrance devices (e.g., disks, tapes, semi-conductor memories, etc.). For example, a module (such as module 310, shown in FIG. 1) may be implemented in the form of such an apparatus, by storing program code in one or more of the data-remembrance devices, and by causing the stored code to execute on one or more of the processors.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A system comprising:
a display that shows a representation of a geographic region;
an input device that receives a first specification of an arbitrary, non-predefined sub-region of said geographic region;
one or more data remembrance devices;
one or more processors;
a communicative connection among said one or more data remembrance devices and said one or more processors;
data pertaining to one or more objects or events, said data comprising:
first data descriptive of locations, within said geographic region, of said one or more objects or events; and
second data that pertains to one or more aspects of said one or more objects or events, said one or more aspects being other than the locations of said one or more objects or events; and
a module that is stored in at least one of said one or more data remembrance devices, that is executable on at least one of said one or more processors, and that provides information, to a person, about those one or more objects or events that, according to said first data, stand, within a level of certainty, in a definable relationship to said sub-region.

2. The system of claim 1, wherein those objects or events that stand in said definable relationship to said sub-region satisfy one of the following:
the objects or events are within said sub-region;
the objects or events touch a boundary of said sub-region;
the object or events define an area that intersects said sub-region; or
the objects or events are outside said sub-region.

3. The system of claim 1, wherein said input device receives boundaries for a polygon, and wherein the polygon constitutes said first specification of said sub-region.

4. The system of claim 1, wherein said display comprises a tactilely-sensitive screen, wherein said input device comprises said tactilely-sensitive screen, and said first specification is received by said input device by said person drawing a boundary within said geographic region on said tactilely-sensitive screen.

5. The system of claim 1, wherein said system receives a second specification of an analysis to be performed with respect to said one or more objects or events, wherein said module performs said analysis based on factors comprising: (a) which objects or events, according to said first data, stand, within said level of certainty, in said definable relationship to said sub-region, and (b) said second data, and wherein said information comprises, or is based on, one or more results of said analysis.

6. The system of claim 5, wherein said module performs said analysis only on such portion of said second data that pertains to those one or more objects or events that, according to said first data, stand, within said level of certainty, in said definable relationship to said sub-region.

7. The system of claim 5, wherein said second specification defines a predicate, wherein said one or more results indicate a set of one or more objects or events whose membership is limited to objects or events that, according to said first data and within said level of certainty, stand within said definable relationship to said sub-region and satisfy said predicate, and wherein said information is provided to said person by indicating locations of said objects or events in said set.

8. The system of claim 7, wherein said indicating of locations of said objects in said set is performed by indicating said objects on said display within said representation of said geographic region.

9. The system of claim 5, wherein said second specification defines a predicate, wherein said results comprise an indication as to whether said sub-region satisfies said predicate, and wherein said results are based on said first data and said second data.

10. The system of claim 9, wherein said results comprise an indication as to whether objects or events that fall within said sub-region collectively satisfy one or more criteria defined in said predicate.

11. The system of claim 9, wherein said information is provided by showing said sub-region on said display in a first color if said sub-region satisfies said predicate, and by showing said sub-region in a second color different from said first color if said sub-region does not satisfy said predicate.

12. One or more computer-readable storage media encoded with computer-executable instructions to perform a method, the method comprising:
receiving a first specification describing an arbitrary, non-predefined sub-region of a geographic region;
receiving data about one or more objects or events, said data comprising:
first data descriptive of locations, within said geographic region, of said one or more objects or events; and
second data that pertains to one or more aspects of said one or more objects or events, said one or more aspects being other than the locations of said one or more objects or events; and
providing, to a person, information about those one or more objects or events that, according to said first data, stand, within a level of certainty, in a defined relationship to said sub-region.

13. The one or more computer-readable storage media of claim 12, wherein the method further comprises:
displaying, on a tactilely-sensitive screen, said geographic region;
and wherein said receiving of said first specification is performed through said tactilely-sensitive screen by said person drawing a boundary within said geographic region on said tactilely-sensitive screen.

14. The one or more computer-readable storage media of claim 12, wherein the method further comprises:
receiving a second specification of an analysis to be performed with respect to said one or more objects or events; and
performing said analysis based on factors comprising: (a) which objects or events, according to said first data, stand, within said level of certainty, in said definable relationship to said sub-region, and (b) said second data, and wherein said information comprises, or is based on, one or more results of said analysis.

15. The one or more computer-readable storage media of claim 14, wherein said analysis is performed only on such portion of said second data that pertains to those one or more objects or events that, according to said first data, stand, within said level of certainty, in said definable relationship to said sub-region.

16. The one or more computer-readable storage media of claim 14, wherein said second specification defines a predicate, wherein said one or more results indicate a set of one or more objects or events whose membership is limited to objects or events that, according to said first data and within said level of certainty, stand within said definable relationship to said sub-region and satisfy said predicate, and wherein the act of providing information to said person comprises:
displaying, on a screen, a representation of said geographic region, an indication of the boundary of said sub-region, and an indication of the one or more objects or events in said set.

17. The one or more computer-readable storage media of claim 14, wherein said second specification defines a predicate, wherein said results comprise an indication as to whether said sub-region satisfies said predicate, and wherein said results are based on said first data and said second data.

18. The one or more computer-readable storage media of claim 17, wherein said results comprise an indication as to whether objects or events that fall within said sub-region collectively satisfy one or more criteria defined in said predicate.

19. The one or more computer-readable storage media of claim 17, wherein the act of providing said information to said person comprises:
displaying on said screen said sub-region in a first color if said sub-region satisfies said predicate, and by showing said sub-region in a second color different from said first color if said sub-region does not satisfy said predicate.

20. A method comprising:
receiving a first specification describing an arbitrary, non-predefined sub-region of a geographic region;
receiving a second specification of a predicate;
receiving data about one or more objects or events, said data comprising:
first data descriptive of locations, within said geographic region, of said one or more objects or events; and
second data that pertains to one or more aspects of said one or more objects or events, said one or more aspects being other than the locations of said one or more objects or events; and
displaying, on a screen, information comprising:
a representation of said geographic region;
an indication of said sub-region; and
visual information indicative of whether those ones of said one or more objects or events that lie within said sub-region collectively satisfy said predicate.
